(19) United States
(12) Patent Application Publication
(10) Pub. No.: US 2015/0053676 A1
(43) Pub. Date: Feb. 26, 2015

(54) MULTI-TIER ASSEMBLY FOR SUPPORTING SUCH AS ICE CREAM CONES AND CUPCAKES IN SPATIALLY STACKED FASHION

(71) Applicant: MICHELLE SAND, Macomb, MI (US)

(72) Inventor: MICHELLE SAND, Macomb, MI (US)

(21) Appl. No.: 14/454,411

(22) Filed: Aug. 7, 2014

Related U.S. Application Data
(60) Provisional application No. 61/868,322, filed on Aug. 21, 2013.

(51) Int. Cl. A47J 47/14; A45C 11/20

(52) U.S. Cl. CPC A47J 47/14; A45C 11/20
USPC 220/4.27; 220/507

(57) ABSTRACT

A multi-tiered assembly for carrying pluralities of items and including a multi base, within an open interior of which is nested or inserted at least one intermediate body. A lid is secured over the base and intermediate body and an inter-engagement mechanism is associated with each exterior facing side of the base, lid and intermediate body for assembling the base, lid and body into a tier defining enclosure for holding and transporting the items. A pair of intermediate bodies may further include each a primary tier defining body and a secondary tier defining body. The base may further include a recessed flat interior and upwardly extending and interconnecting side and end walls. Each of the primary and secondary tier defining bodies can, in a preferred embodiment, exhibit a generally similar four sided profile incorporating a plurality of inner perimeter defined and item receiving apertures.

### CROSS REFERENCE TO RELATED APPLICATIONS

This application claims the benefit of U.S. Provisional Application 61/868,322 filed on Aug. 21, 2013, the contents of which is incorporated herein in its entirety.

### BACKGROUND OF THE INVENTION

1. Field of the Invention

The present invention relates generally to a stacking assembly for carrying objects in spatially arrayed and multi-tier fashion. More specifically, the present invention discloses a multi-tier nesting assembly for maintaining in safe and spatially arrayed fashion pluralities of items, such as cupcakes, ice cream cones and other edibles. The multi-component assembly is further capable of being reconfigured to modify a number of individual tiers. Additional pan or tray shaped inserts can be provided to establish different supporting surfaces, such as in one notable example converting from holding cupcakes to a cones or the like.

2. Description of the Prior Art

The prior art is documented with examples of multi-section containers, trays and the like. A first example of this is the multi-sectioned container of Smith, US 2004/0262306, which includes bottom and upper stackable sections. The bottom section includes a bottom surface and a side-wall that includes, at a top portion thereof, a connector for connecting the bottom section to an upper section stacked thereon. The connector may be screw threads or a snapping mechanism. The upper section is essentially a tube that is configured in a bottom portion thereof to connect to the bottom section. The upper section is also configured at a top portion thereof to connect, selectively, to another stacked upper section or a lid.

Wischhusen, U.S. Pat. No. 5,116,240 and U.S. Pat. No. 5,016,756, both disclose a multi-partition food storage and multiple serving apparatus is disclosed and includes a cover portion and a tray portion which mate to foam a plurality of insulated cavities. A plurality of types of bowls are removably insertable in any of the cavities. Each bowl includes a separate lid and is capable of holding multiple serving portions. The insulation provided between each cavity allows simultaneous transport and storage of different foods which may be maintained at different temperatures.

Brabson, II (U.S. Pat. No. 6,415,940) teaches a compartmented container formed of a can and having a rigid divider wall dividing two sub-volume spaces. Daitch, U.S. Pat. No. 7,401,701, teaches a multi-component package attachment apparatus and method for coupling a plurality of items with such as a food package. One or more of the compartments may include thermal protective layers to keep such as condiments from melting when hot food packages are stacked.

Malone, U.S. Pat. No. 8,651,279, teaches a container system having upper and lower inter-engageable compartments for receiving such as separate food components. A pull tab can be configured to pull while the upper container assembly is engaged with the lower container to at least partially open the upper container assembly. Other references of note include the tiered lunchbox depicted in Clark, U.S. Pat. No. 1,142,932, the stackable plate construction of FR 2903079, and the multi-purpose bracket tray type fresh dumpling packing box of CN 2011/79988.

### SUMMARY OF THE PRESENT INVENTION

The present invention discloses a multi-tiered assembly for carrying pluralities of items and including a multi base, within an open interior of which is nested or inserted at least one intermediate body. A lid is secured over the base and open interior defined within the intermediate body and an inter-engagement mechanism is associated with each exterior facing side of the base, lid and intermediate body for assembling the base, lid and body into a tier defining enclosure for holding and transporting the items.

A pair of intermediate bodies may further include each a primary tier defining body and a secondary tier defining body. The base may further include a recessed flat interior and upwardly extending and interconnecting side and end walls. Each of the primary and secondary tier defining bodies can, in a preferred embodiment, exhibit a generally similar four sided profile incorporating a plurality of inner perimeter defined and item receiving apertures.

Other features include at least one tray for modifying the carrying capabilities of the assembly and which is adapted to being inserted into at least one of the base or upper tier defining body. Each of the trays can likewise exhibit a rectangular profile and each further including a plurality of cupcake holding depressions which facilitate the trays being seated over the inner apertures of the bodies.

At least one of the trays may further include a plurality of edge defined and spaced notches aligning with a plurality of inner vertical protrusions defined upon at least the main tier defining body to permit the trays to slide downwardly within the base. For ease of handling, each of the trays can further incorporate edge defined handles.

Additional features include an inter-engagement mechanism having a first linkage pivotally supported upon a pedestal mounting flange, a second linkage pivotally connected to the first linkage in a reverse/upwardly extending fashion and terminating in an integrally formed and inwardly facing hook. The inter-engagement mechanism may further exhibit a seating recess profile defined in an opposing nesting location associated with each of the tier defining bodies and/or the lid and, upon manipulating the first and second linkages, the hook of a selected linkage seating within a seating recess profile to define a cam actuated hold-down linkage.

Yet additional aspects associated with the inter-engagement mechanism further include provision of an arcuate and hingedly supported/pivotal outer tab defining at least one window, each of the tier defining bodies and the lid further having a lateral projecting ledge such that, upon the tab being rotated upwardly about its hinge so that the ledge seats through an upper edge of the aligning window portion. Each of the ledges may further exhibit a rounded profile for facilitating seating of the upwardly rotated tab.

An additional variant contemplates the main body having an open bottom and perimeter extending inner ledge which receives a lower-most insertable tray, the trays further being configured to receive any plurality of cups. Related applications of the assembly expand beyond the carrying of edible items (e.g. cupcakes, cones, etc.,) and which can include such as use by scrap bookers for holding office supplies and accessories (paper clips, push pins, etc,), as well as use for holding hardware (screws, nuts, etc,).

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the multi-tier assembly according to a first configuration and exhibiting an assembled and inter-nesting configuration for supporting pluralities of items in interiorly stacked fashion;

FIG. 2 is an exploded view of the multi-tier assembly depicted in FIG. 1 and better illustrating the engagement profiles established between the base, lid and intermediate item supporting tiers;

FIG. 3 is a modified configuration in comparison to that depicted in FIG. 2 and illustrating a pair of cupcake supporting trays provided for modifying the carrying capabilities of the assembly;

FIG. 4 is a further exploded perspective of a base and lid in a most simplified carrying arrangement;

FIG. 5 is a side cutaway of a locking arrangement such as established between base and nesting lid, this including a cam actuated hold-down linkage for compressing the lid into engagement with the base;

FIG. 6 is a succeeding view to FIG. 5 and showing the linkage in a pivoted and unseating arrangement;

FIG. 7 illustrates in phantom an edge engagement profile associated with an intermediate stacked tier which, in combination with the linkage, provides for secure engagement and carry-ability of the assembly;

FIG. 8 is an operational plan cutaway of the assembly in a given configuration for establishing a pair of tiers for carrying such as cone supporting items;

FIG. 9 is a top plan view of an intermediate tier such as depicted in FIG. 2 and illustrating the multiple seating apertures for supporting a tier of items;

FIG. 10 is an illustration similar to FIG. 8 of a second configuration establishing a four tier assembly for supporting such as cupcake shaped articles;

FIG. 11 is an illustration similar to that shown in FIG. 1 and depicting an alternate edge engagement profile to the linkages for establishing snap-in securing of the assembly tiers;

FIG. 12 is an exploded view of the multi-tier assembly depicted in FIG. 11 and better illustrating the engagement profiles established between the base, lid and intermediate item supporting tiers utilizing the tab and slot profiles;

FIG. 13 is a modified configuration in comparison to that depicted in FIG. 12 and illustrating a pair of supporting trays provided for modifying the carrying capabilities of the assembly;

FIG. 14 is a further exploded perspective of a base and lid from the embodiment of FIG. 11 and in a most simplified carrying arrangement;

FIG. 15 is an edge engagement profile in side cutaway of the tab and slot arrangement of FIG. 11 and which provides for secure engagement and carry-ability of the assembly;

FIG. 16 is a succeeding illustration to FIG. 15 depicting the manner in which an intermediate tier is incorporated into the tab and slot configuration;

FIG. 17 is an illustration similar to that presented in FIG. 8 of the embodiment of FIG. 11 and depicting an operational plan cutaway of the assembly in a given configuration for establishing a pair of tiers for carrying such as cone supporting items;

FIG. 18 is a corresponding illustration similar to that presented in FIG. 9 of a top plan view of an intermediate tier such as depicted in FIG. 12 and illustrating the multiple seating apertures for supporting a tier of items;

FIG. 19 is an illustration similar to FIG. 17 of a second configuration establishing a four tier assembly for supporting such as cupcake shaped articles; and

FIG. 20 is a variant of FIG. 13 and depicting an exploded view of a modification of a multi-tier assembly with a main body having an open bottom and perimeter extending inner ledge which receives a lower-most insertable tray, the trays further being configured to receive any plurality of cups.

### DETAILED DESCRIPTION OF THE PREFERRED EMBODIMENTS

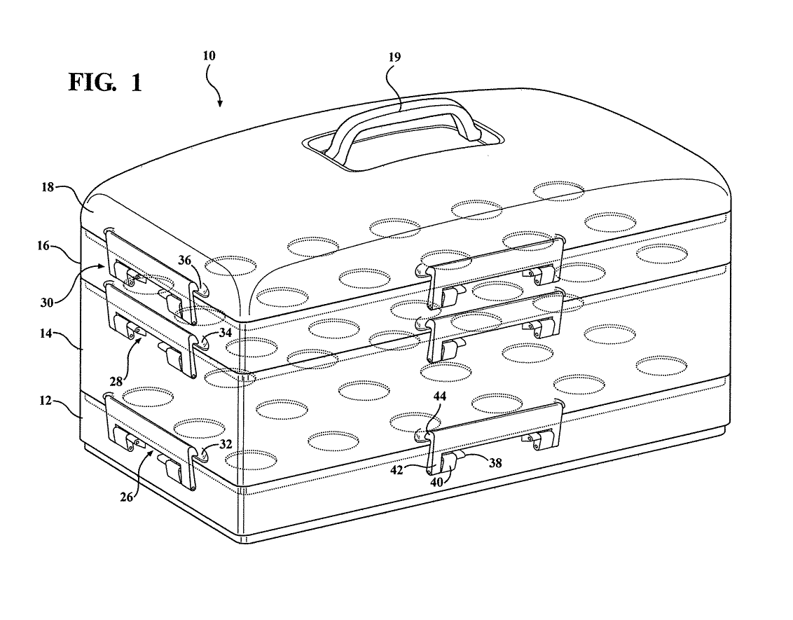

Referring now to FIGS. 1-20, the present invention discloses a number of related variants directed to a multi-tier nesting assembly, generally at 10 in FIG. 1, for maintaining in safe and spatially arrayed fashion pluralities of items, such as cupcakes, ice cream cones and other edibles. As will be further described in detail with reference to the succeeding illustrations, the multi-component assembly is further capable of being reconfigured to modify a number of individual tiers. As will be subsequently described additional pan or tray shaped inserts can be provided to establish different supporting surfaces, such as in one notable example converting from holding cupcakes to a cones or the like.

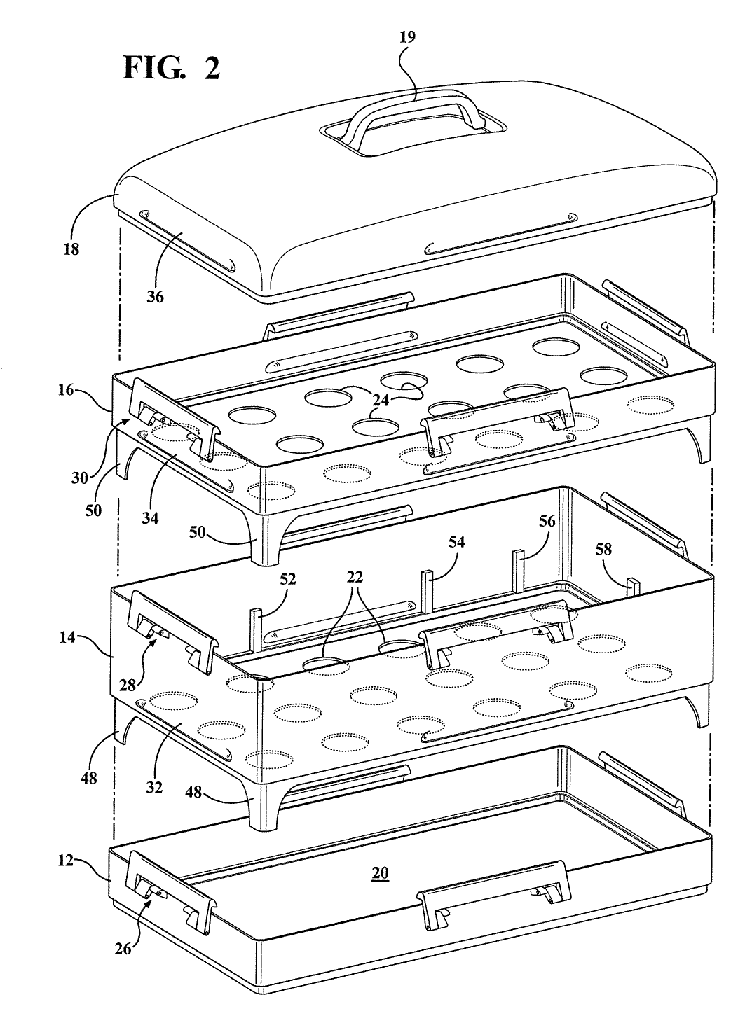

Referring again to FIG. 1, the multi-tier assembly is depicted in perspective according to a first configuration and which exhibits an assembled and inter-nesting configuration for supporting pluralities of items in interiorly stacked fashion. This is further depicted in the exploded view of FIG. 2 of the multi-tier assembly depicted in FIG. 1 and which better illustrates the engagement profiles established between base 12, primary (lower) tier/depth defining body 14, secondary (upper) tier/depth defining body 16 and corresponding multi-sided and depth defining lid 18 with an upper/middlemost arranged grasping handle 19.

As shown, each of the base, lid and intermediate tiers are shown exhibiting a generally rectangular configuration and each exhibits a narrowed lower channel edge to facilitate inter-seating or nesting of one section atop another. It is understood that the assembly can include other shapes or profiles, such as any of triangular to circular shapes, and which can further exhibit any height/depth or number of individual product holding tiers.

It is further understood that the individual bodies defining each of the components can further be constructed of any suitable material not limited to aluminum or durable plastic. Other variants contemplate warming or refrigerated applications in which appropriate resistance elements or chilling units are included for assisting in maintaining a desired temperature of a given product supported in plural tiered fashion.

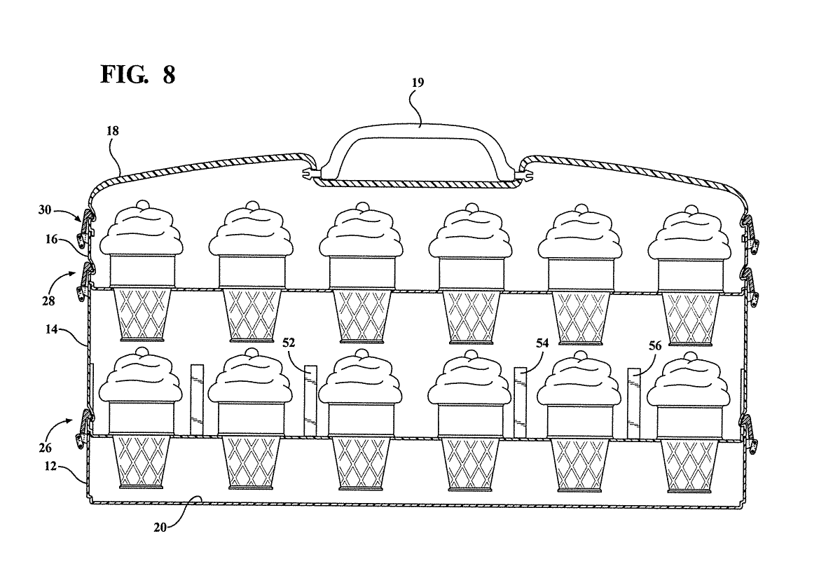

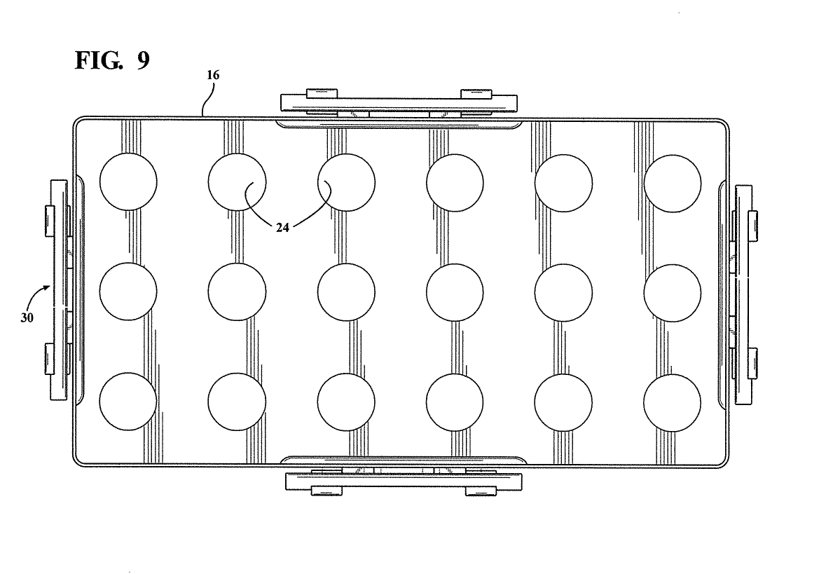

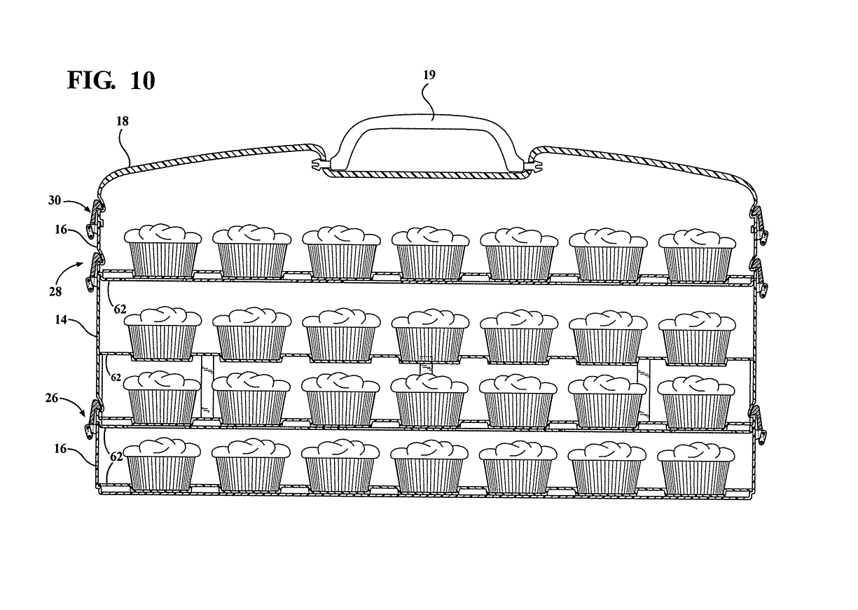

The base 12 includes a recessed flat interior 20 and upwardly extending and interconnecting side and end walls. Each of the primary 14 and secondary 16 tiered bodies exhibit a generally similar (four sided) profile and each further depicts a plurality of inner perimeter defined apertures established by closed inner perimeters (see at 22 and 24 respectively for bodies 14 and 16) and which are defined in distributed fashion across the surface of each body for receiving, such as in inwardly seating fashion, such as cones (FIG. 8) or cupcakes (FIG. 10).

A plurality of inter-engagement mechanism are provided at aligning outer locations for securing together in a desired stacking arrangement any combination of the individual components (base, tiered bodies, lid). In one illustrated variant, each such linkage is configured upon an exterior side of each of the base 12 and primary/secondary tiers 14/16, and as generally represented in FIG. 2 by each selected linkages 26, 28 and 30, it being understood that any plurality of such linkages can be defined along some or all of the exterior interconnected sides of the assembly. For purposes of ease of illustration, only selected linkages are referenced in the attached illustrations, it being understood that the remaining linkages are likewise constructed such that a repetitive description is unnecessary.

As further depicted in FIG. 5, a side cutaway is depicted of a locking arrangement such as established between selected linkage 26 associated with base 12 and a recessed and exterior facing and seating profile 32 associated with an edge aligning location of the primary tier defining body 14. Additional tiered seating profiles are also shown at 34 upon secondary tier body 16 for receiving aligning linkage 28 associated with primary body 14, as well as at 36 upon lid 18 for receiving linkage 30 of secondary body 16. As is further shown, the tiered seating profiles (again best shown at 32 in FIGS. 5-6) can be configured along each outwardly facing side of the lid 18 and body 14.

As further depicted in FIGS. 5-7, representative linkage 26 is secured to one exterior edge of the lid 12 includes a pedestal mounting flange 38, to which is pivotally secured a first link 40. A second link 42 is also pivotally connected to the first link in a reverse (upwardly) extending fashion and terminates in an integrally formed and inwardly facing hook 44. The links 40 and 42 collectively define a cam actuated hold-down linkage for compressing each of the tiered components into the upper seating recess profile (e.g. see nesting profile 44 also shown in reference to primary tier defining body 14).

As shown in FIG. 2, each edge configured linkage is designed such that it can be grasped by a user and, upon being rotated outwardly such as is represented at 26′ in FIG. 6, unseats the hook 44 from the seating recess 32 and allows the upper tiered component to be withdrawn (FIG. 7). As further shown in FIG. 7, illustrated in phantom 46 is an edge engagement profile associated with any item, not limited to the intermediate stacked tier or lid, and which, in further combination with the linkage, provides for secure engagement and carry-ability of the assembly. Without limitation, the underside aperture defined by the main (second 42) linkage is dimensioned to permit a user to grasp the ends of the opened base or intermediate tier with his/her fingers or using any suitable hook shaped tool or utensil as shown.

Referring back to FIG. 2, the primary 14 and secondary 16 tier defining bodies each further exhibit downwardly extending foot supports, see at 48 and 50 respectively. Also shown at 52, 54, 56 and 58 are selected vertical protrusions associated with a pair of inner facing sides of the primary body 14.

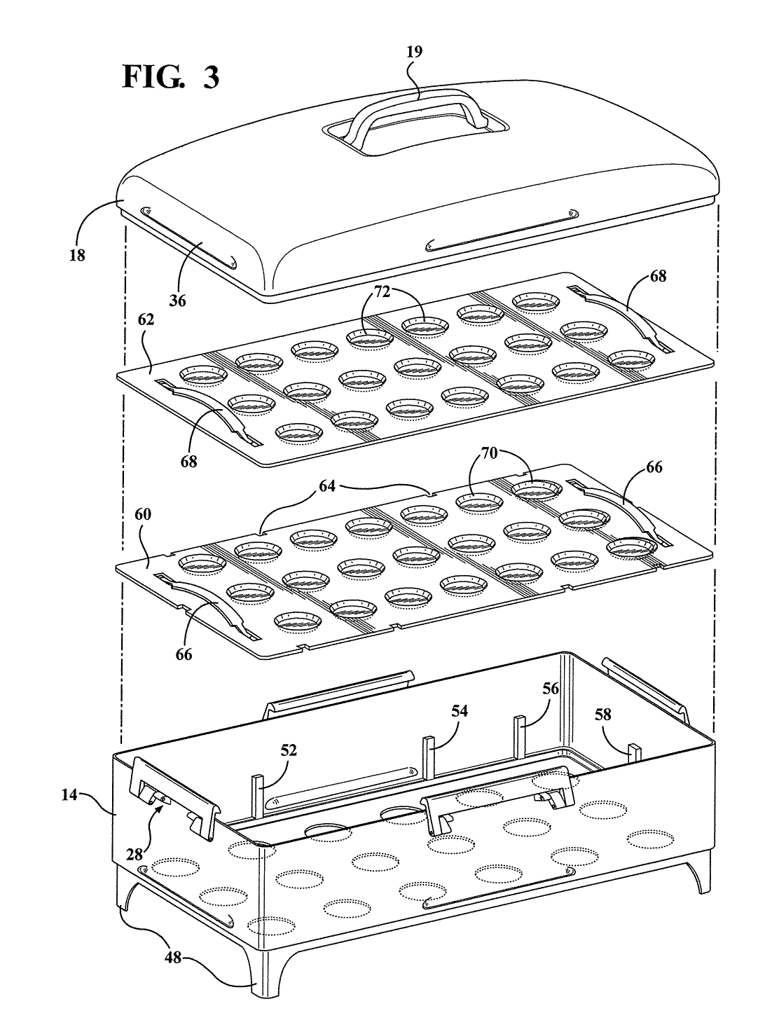

FIG. 3 is a modified configuration in comparison to that depicted in FIG. 2 and illustrating a pair of cupcake supporting inserts or trays 60 and 62 provided for modifying the carrying capabilities of the assembly and which are used in combination with only the lower/main tier defining body 14 and lid 18. As previously described, the present invention contemplates a variety of differing configurations in which any combination of components can be arranged or rearranged in order to achieve a desired carrying configuration or capacity.

Each of the trays 60 and 62 exhibits a rectangular profile, with tray 60 further exhibiting a plurality of edge defined and spaced notches 64, these aligning with the inner vertical protrusions 52, 54, 56, 58 et seq. defined upon the main tier body 14 (again FIG. 2) and which, upon aligning the tray 64 over the body 14, permit the tray to slide downwardly. The trays 60 and 62 further each exhibit edge defined handles (see at 66 for tray 60 and at 68 for tray 62). Each of the trays further exhibits a plurality of cupcake holding depressions (see at 70 for tray 60 and at 72 for tray 62), the design of which facilitates the trays being seated over the inner apertures 22 and 24 of the bodies 14 and 16 and to enable the assembly to be reconfigured to hold a volume of (cupcake) product in supported fashion upon the tray, and as opposed to extending through the aperture and being supported by the inner rim of the apertures (e.g. ice cream cones).

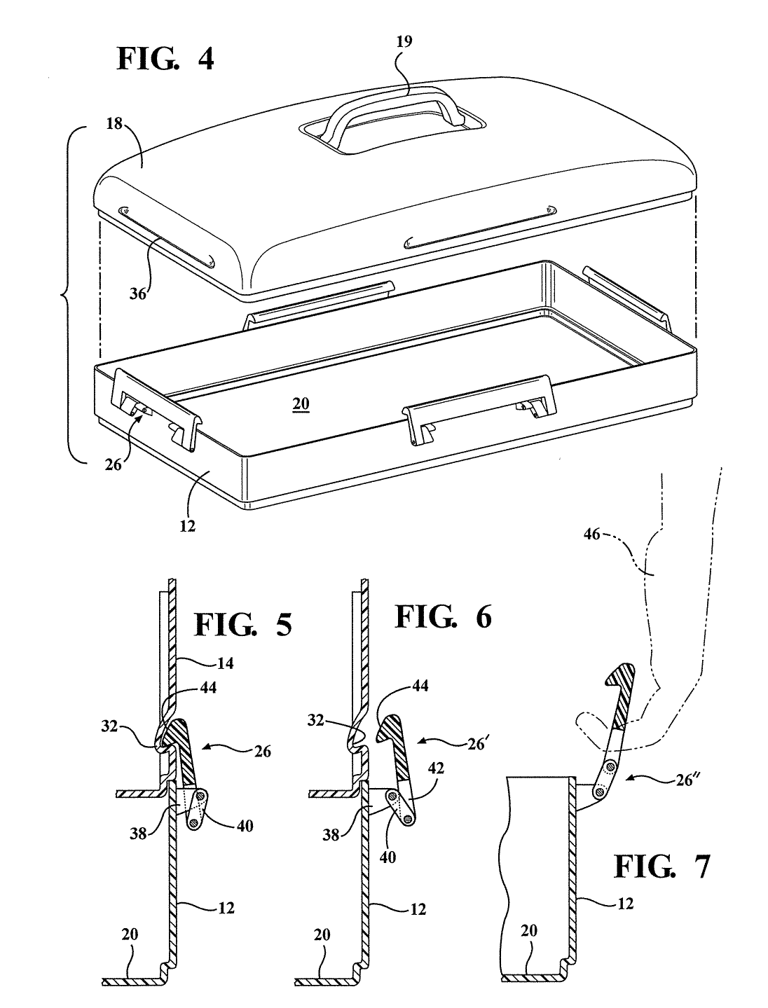

FIG. 4 is a further exploded perspective of a base 12 and lid 18 in a most simplified carrying arrangement and in which the plurality of four edge located linkages (see again selected linkage mechanism 26) are provided upon the base for engaging the opposing recess edge profiles (e.g. again at 36) extending along the four exterior sides of the lid. FIG. 8 is an operational plan cutaway of the assembly in a given configuration (see again FIG. 2) for establishing a pair of tiers for carrying such as cone supporting items.

FIG. 9 is a top plan view of an intermediate tier such as depicted at 16 in FIG. 2 and illustrating the multiple seating apertures for supporting a tier of items. FIG. 10 is an illustration similar to FIG. 8 of a second configuration establishing a four tier assembly for supporting such as cupcake shaped articles, this provided by a plurality of four insert trays similar to those shown at 60 and 62 in FIG. 3 and which are used in combination with the four tiered arrangement of FIG. 2.

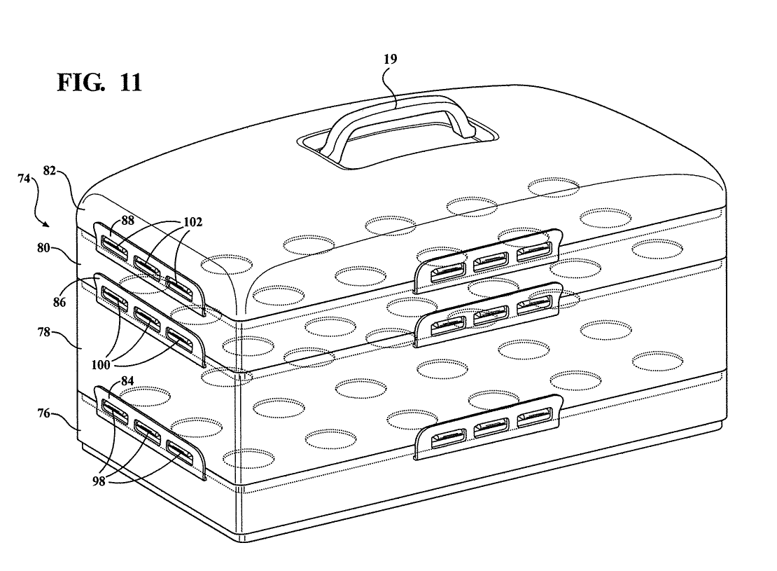

Proceeding now to FIGS. 11-19, a second variant of tiered product supporting assembly is shown, generally at 74, and which is largely similar to that depicted at 10 in FIG. 2, again including a base 76 (such again exhibiting a solid bottom surface), a main/lower tier defining body 78 (such having a plurality of distributed inner rim defining apertures 79) along with the vertical protrusions as representatively shown at 52, 54, 56, et. seq., a secondary/upper tier defining body 80 (with additional rim defining apertures 81) and a lid 82. The multi-tier body differs from that previously described only in the configuration of the structure for inter-engaging the individual stacked or nesting sections. These include aligning edge configured tabs and receiving slots for snapping engagement of one section atop another.

Specifically, any number of exterior facing sides (and in the illustrated variant all four exterior facing sides) of each of the base 76, main body 78 and secondary/upper stacking body 80 exhibit an arcuate and pivotal outer tab, shown at 84, 86 and 88, respectively. FIG. 15 illustrates a selected tab 84 and such as which can include a living hinge construction (further at 90) to facilitate an unlimited number of pivoting cycles (see between positions 84 and 84′).

The tabs each further exhibit a plurality of spaced seating windows (see three such rectangular shaped windows arranged in horizontal spaced fashion at 92 for selected tab 84, with additional pluralities of windows 94 and 96 for each corresponding upper tab 86 and 88). The main body 78, secondary body 80 and lid 82 each further includes a reconfigured plurality of lateral projecting ledges, these being shown at 98, 100 and 102 configured upon a lower proximate edge of each side of main body 78, upper/secondary body 80 and lid 82.

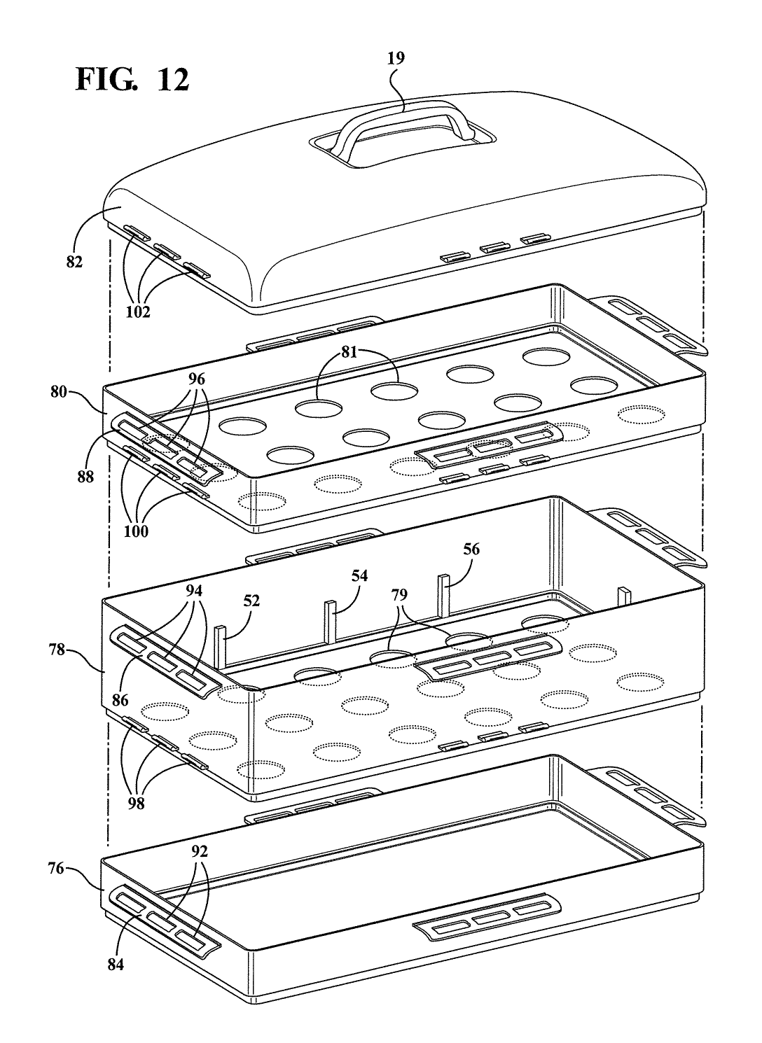

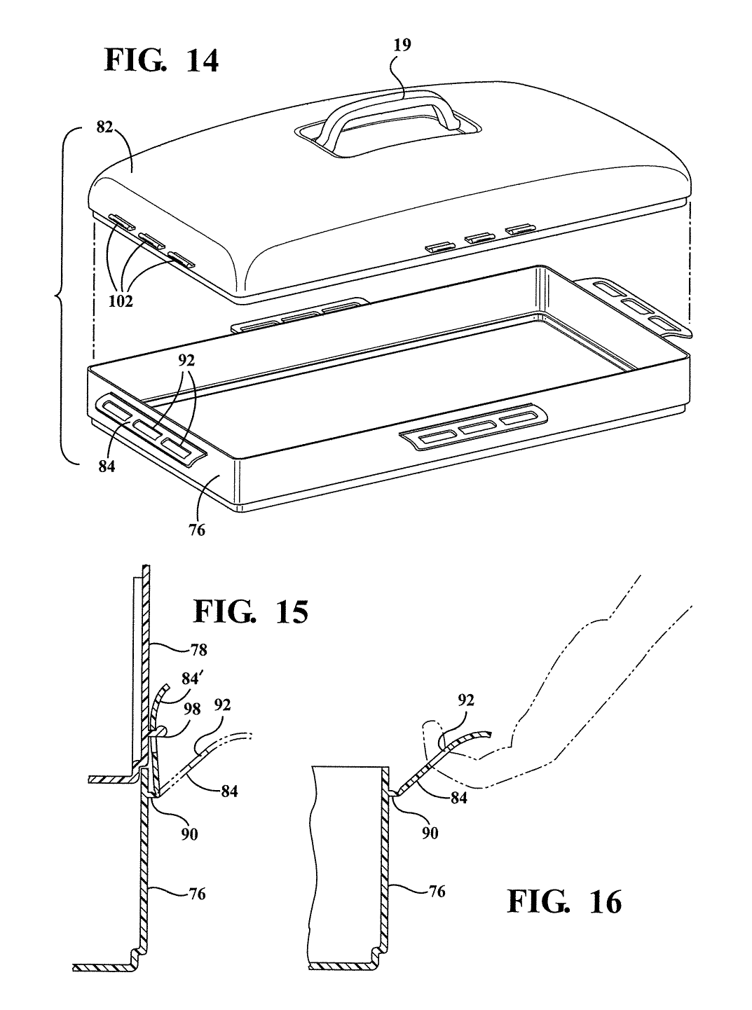

As best shown in FIG. 16, engagement of the tabs to the projecting ledges is accomplished by nesting one component atop another (such as the multi-tiered arrangement of FIG. 12 or the lid and base arrangement of FIG. 14), following which the tab is rotated upwardly about its hinge so that the ledge 98, 100 or 102 seats through the upper edge of the aligning window portions (see again at 92, 94 and 96). As further shown in FIG. 15, each of the ledges (e.g. at 98) can exhibit a rounded profile for facilitating seating of the upwardly rotated tab and in a manner which secures the sections together quickly and effectively.

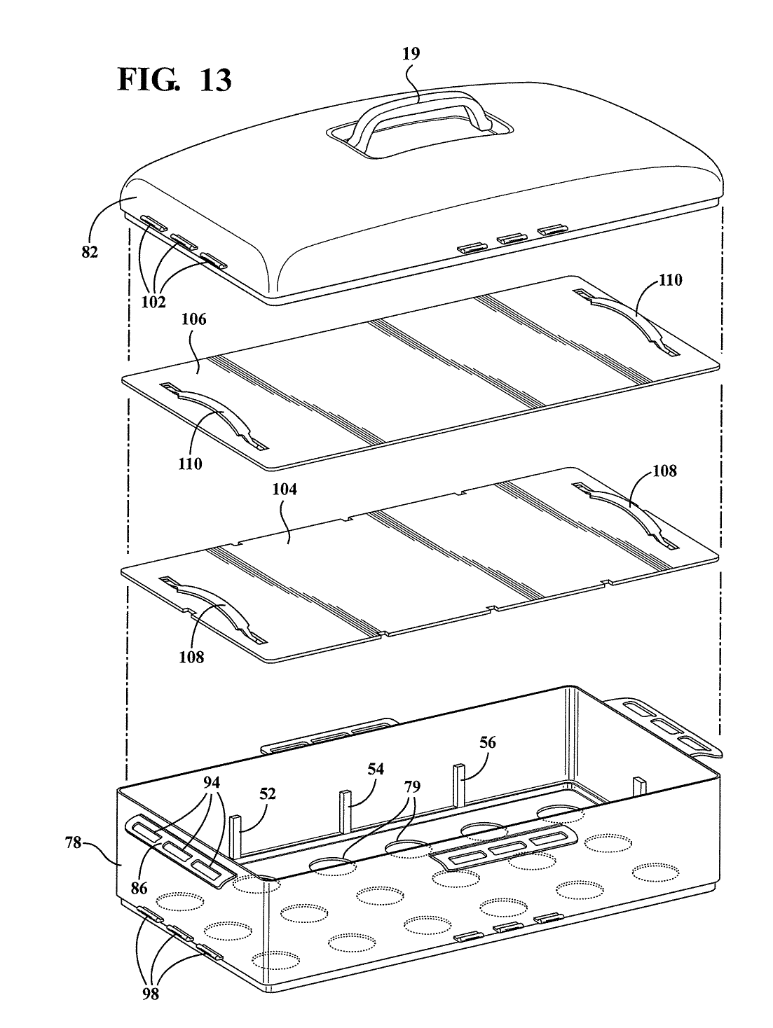

FIG. 13 is a modified configuration in comparison to that depicted in FIG. 12 and illustrating a pair of supporting trays 104 and 106 are provided for modifying the carrying capabilities of the assembly. The trays 104 and 106 include end configured handles, at 108 and 110, respectively and define flat supporting profiles for establishing interior defined tiers. The construction of the trays and seating/guiding protrusions associated with the main body 78 are again shown as previously described in the initial embodiment and as depicted in FIG. 3.

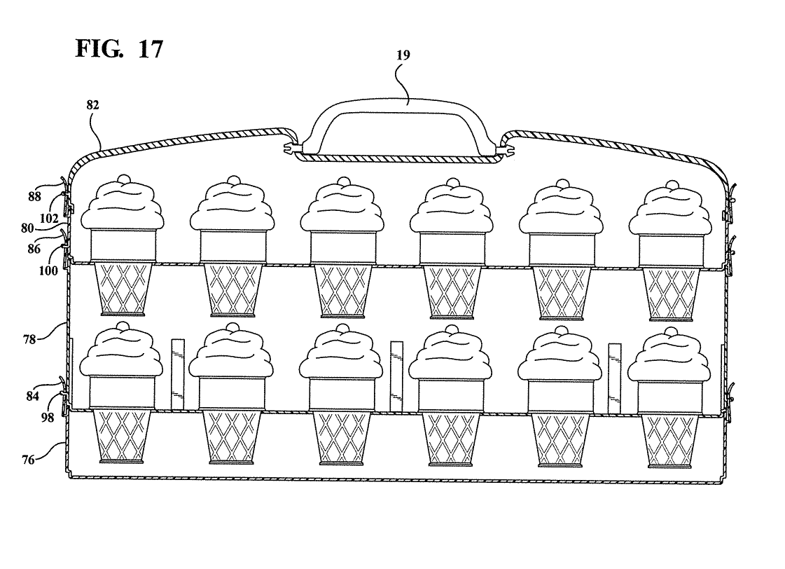

FIG. 14 is a further exploded perspective of a base 76 and lid 82 from the embodiment of FIG. 11 and in a most simplified carrying arrangement. FIG. 17 is an illustration similar to that presented in FIG. 8 of the embodiment of FIG. 11 and depicting an operational plan cutaway of the assembly in a given configuration for establishing a pair of tiers for carrying such as cone supporting items.

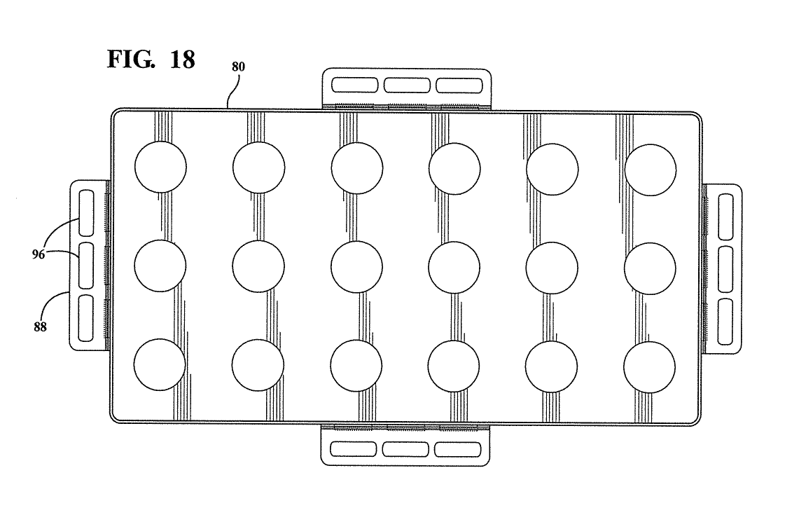

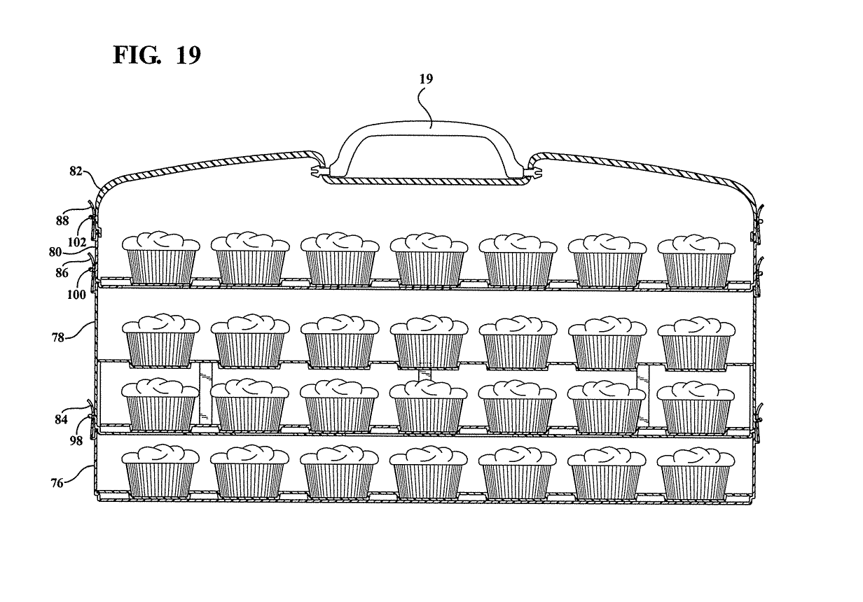

FIG. 18 is a corresponding illustration similar to that presented in FIG. 9 of a top plan view of an intermediate tier such as depicted in FIG. 12 and illustrating the multiple seating apertures for supporting a tier of items. Finally, FIG. 19 is an illustration similar to FIG. 17 of a second configuration establishing a four tier assembly for supporting such as cupcake shaped articles.

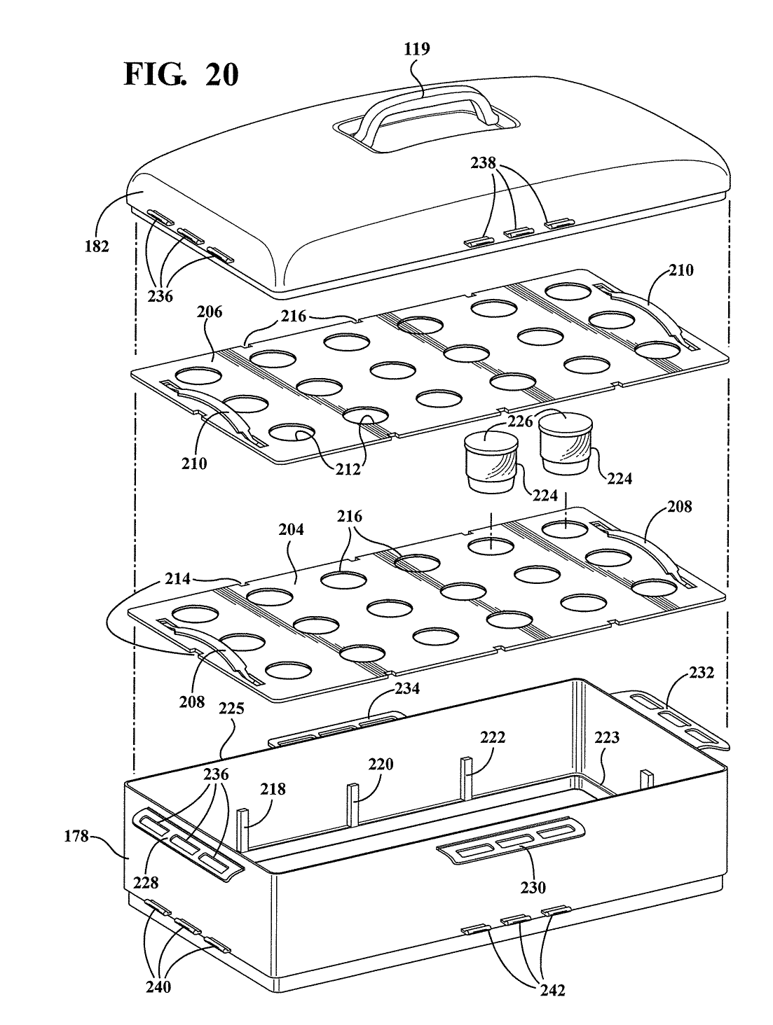

FIG. 20 is a variant of FIG. 13 and depicting an exploded view of a modification of a multi-tier assembly with a main body having an open bottom and perimeter extending inner ledge which receives a lower-most insertable tray, the trays further being configured to receive any plurality of cups. A main body or base 178 (this similar to as previously at 78 in FIG. 13) includes similarly arranged and individual pluralities of lateral projecting ledges, further selectively shown at 198.

A pair of supporting trays 204 and 206 are modified from those depicted at 104 and 106 in FIG. 13 and are provided for modifying the carrying capabilities of the assembly. The trays 204 and 206 include end configured handles, at 208 and 210, respectively and define flat supporting profiles for establishing interior defined tiers. The construction of the trays and seating/guiding protrusions associated with the main body 178 are again shown as previously described in the initial embodiment and as depicted in FIG. 3, with the exception that they further each provide pluralities of distributed apertures across their planar surfaces, see further inner closed perimeter edges 210 for tray 204 and 212 for tray 206.

As with preceding embodiments, each of the trays 204 and 206 include outer edge configured notches (see further at 214 and 216, respectively) arranged around the outer perimeter of the trays. The pluralities of notches 214 and 216 seat similarly configured vertical protrusions, further at 218, 220, 222, et. seq. as compared to at 52, 54, 56 in FIG. 2, such that the trays 204 and 206 can be seated at selected heights within the main body interior.

In this fashion, the lower selected tray 204 can descend in seating fashion within the interior of the main body or base, such that the edges of the tray 204 abut a lowermost inner perimeter extending ledge 223 associated with the base 178 It is also envisioned that the notches 216 associated with the upper tray 206 can be removed (such as shown by tray 106 in FIG. 13) and in order that the underside edge of the tray 106 seats upon the upper level surfaces of the vertical protrusions 218, 220, 222.

Also depicted in FIG. 20 are the provision of a plurality of removable objects, such as cups 224, the outer annular surfaces of which seating within the inner perimeter edges 210 and 212 of the tray apertures. The cups can include such as removable lids (see at 226) and are capable of holding either of edible or non-edible items. Additional potential applications of the multi-tier assembly include storing and transporting items related to any of scrap-booking, hardware related items or the like.

Also shown in FIG. 20 is an interlocking structure for securing lid 182 to the upper perimeter edge (at 225) of the main body or base 178, and which, similar to as shown in FIG. 12, includes a plurality of arcuate profile and elongated tabs, at 228, 230, 232 and 234, defined along each of the outer facing sides of the base 178, and which can again exhibit a living hinge construction to facilitate an unlimited number of pivoting cycles (see between positions 84 and 84′ as previously depicted in FIG. 15). The elongated tabs 228, 230, 232 and 234 each further exhibit a plurality of spaced seating windows (see three such rectangular shaped windows arranged in horizontal spaced fashion at 236 for selected tab 228), with additional pluralities of windows for each corresponding upper tabs 230, 232 and 234).

Similar to FIG. 12, each of the lid 182 (compare to lid 82 in FIG. 12) and base 178 (compare further to at 78) again includes a reconfigured pluralities of lateral projecting ledges configured upon a lower proximate edges, shown at 236 and 238 for selected sides of lid 182 and further at 240 and 242 for selected visible sides of base 178. The tabs as shown can each include an outermost rounded profile and, with respect to the tabs 240/242 shown disposed about the base 178, can be engaged by a successive lower tiered body or base component (not shown), such perhaps exhibiting a closed bottom as previously described and illustrated at 76 in FIG. 12. The operation of the tabs and engaging ledges is further as previously described in FIGS. 15-16 and it is understood that the invention can include such interlocking structure configured upon either some or all of the interconnecting sides of the mating lid and base.

Having described my invention, other additional and preferred embodiments will become apparent to those skilled in the art to which it pertains, and without deviating from the scope of the appended claims. In particular, other types of linkages or engagement mechanisms beyond those depicted herein can be integrated into each of the base, lid and one or more intermediate tier defining bodies.

I claim:

1. A multi-tiered assembly for carrying pluralities of items, comprising:
a multi-sided and depth extending base defining an open interior, said base having a perimeter defining upper edge;
at least one intermediate body supported upon said perimeter defining edge of said base, said intermediate body defining a further open interior;
a lid secured over said intermediate body; and
an inter-engagement mechanism associated with each of exterior facing sides of said base, lid and intermediate body for assembling into a tier defining enclosure for holding and transporting the pluralities of items.

2. The assembly as described in claim 1, said at least one intermediate body further comprising a primary tier defining body and a secondary tier defining body.

3. The assembly as described in claim 2, said base further comprising a recessed flat interior and upwardly extending and interconnecting side and end walls, each of said primary and secondary tier defining bodies exhibit a generally similar four sided profile and each further depicts a plurality of inner perimeter defined and item receiving apertures.

4. The assembly as described in claim 3, further comprising at least one tray for modifying the carrying capabilities of the assembly and which is adapted to being inserted into at least one of said base or upper tier defining body.

5. The assembly as described in claim 4, each of said trays exhibiting a rectangular profile and each further comprising a plurality of cupcake holding depressions which facilitate the trays being seated over the inner apertures of said bodies.

6. The assembly as described in claim 5, at least one of said trays further comprising a plurality of edge defined and spaced notches aligning with a plurality of inner vertical protrusions defined upon at least said main tier defining body to permit said tray to slide downwardly.

7. The assembly as described in claim 6, each of said trays further comprising edge defined handles.

8. The assembly as described in claim 1, said inter-engagement mechanism further comprising a first linkage pivotally supported upon a pedestal mounting flange, a second linkage pivotally connected to said first linkage in a reverse/upwardly extending fashion and terminating in an integrally formed and inwardly facing hook.

9. The assembly as described in claim 8, said inter-engagement mechanism further comprising a seating recess profile defined in an opposing nesting location of each of said tier defining body and/or said lid, upon manipulating said first and second linkages said hook of a selected linkage seating within a seating recess profile to define a cam actuated hold-down linkage.

10. The assembly as described in claim 1, said inter-engagement mechanism further comprising an arcuate and hingedly supported/pivotal outer tab defining at least one window, each of said tier defining bodies and said lid further having a lateral projecting ledge such that, upon said tab being rotated upwardly about its hinge so that said ledge seats through an upper edge of said aligning window portion.

11. The assembly as described in claim 10, each of said ledges further exhibiting a rounded profile for facilitating seating of said upwardly rotated tab.

12. An assembly for carrying pluralities of items, comprising:
a multi-sided base defining an open interior and having a perimeter defining upper edge;
at least one tray insertable within said base, said tray incorporating a plurality of item receiving locations;
a lid secured over said base; and
an inter-engagement mechanism associated with each of exterior facing sides of said base and lid for assembling into a tier defining enclosure for holding and transporting the pluralities of items supported upon said tray.

13. The assembly as described in claim 12, said at least one tray further comprising a pair of supporting trays, each having end configured handles and defining flat supporting profiles for establishing interior defined tiers.

14. The assembly as described in claim 13, said base further comprising pluralities of vertically extending protrusions established along inside sidewall locations, at least one of said trays having outer edge configured notches which align with and are seated by said vertical protrusions such that said trays can be seated at selected heights within said open interior of said base.

15. The assembly as described in claim 14, further comprising an uppermost selected one of said trays exhibiting continuous outer perimeter defining edges which seat upon upper level surfaces of said vertical protrusions for upwardly spacing said tray upon said vertical protrusions.

16. The assembly as described in claim 13, said base further comprising an open bottom defining an inner ledge within which a lowermost selected one of said pair of trays seats.

17. The assembly as described in claim 12, said inter-engagement mechanism further comprising a plurality of arcuate and hingedly supported/pivotal outer tabs secured upon said base, said outer tabs each defining at least one window, said lid further having a matching plurality of lateral projecting ledge such that, upon each of said tabs being rotated upwardly about its hinge, said ledge seats through an upper edge of said aligning window portion.

18. The assembly as described in claim 17, each of said ledges further exhibiting a rounded profile for facilitating seating of said upwardly rotated tab.

19. The assembly as described in claim 12, said item receiving locations in said tray further comprising a plurality of inner perimeter aperture defining edges, a plurality of removable objects each having outer annular surfaces of which seating within said inner perimeter edges.

20. The assembly as described in claim 19, said removable objects further comprising cups with removable lids.
